(19) United States
(12) Patent Application Publication
(10) Pub. No.: US 2007/0088896 A1
(43) Pub. Date: Apr. 19, 2007

(54) Arithmetic processing unit and method for operating cache

(76) Inventors: Masahide Kakeda, Osaka (JP); Masaitsu Nakajima, Osaka (JP); Takao Yamamoto, Osaka (JP); Shinji Ozaki, Osaka (JP)

Correspondence Address: MCDERMOTT WILL & EMERY LLP, 600 13TH STREET, NW, WASHINGTON, DC, 20005-3096, US

(21) Appl. No.: 11/510,670

(22) Filed: Aug. 28, 2006

(30) Foreign Application Priority Data
Oct. 18, 2005 (JP) 2005-303540

(51) Int. Cl. G06F 12/08; G06F 13/00

(52) U.S. Cl. 711/3; 711/141

(57) ABSTRACT

A cache access transmission means outputs an access address, obtained from a CPU by way of a local cache access address input means, to a shared address bus via a remote cache access address output means. A cache access control means accesses a cache memory by using the access address obtained from the shared address bus by way of a remote cache access address input means. That is, an access address output from a CPU of a first processor is output from the cache access transmission means and received by the cache access control means so as to be used in accessing a cache memory in a second processor.

### BACKGROUND OF THE INVENTION

1. Field of the Invention

The present invention relates to a multiprocessor-architecture arithmetic processing unit, and particularly relates to an effective technique for enabling efficient use of local caches from processors.

2. Description of the Related Art

The performance of processors has been improved by increased operating frequency resulting from advances in fabrication process technology and super-pipeline technique, and by parallel processing technology achieved through super-scalar, register rename for raising the efficiency of super-scalar, out-of-order execution, branch prediction, and decrease in CPI (CLOCK CYCLES PER INSTRUCTION) accomplished by speculative execution. Furthermore, in addition to the above-described high-speed packaging technology, processing performance improvement achieved by multiprocessor technology has been often adopted recently.

(Patent document 1) Japanese Laid-Open Publication No. 63-240649 (FIG. 1)

(Patent document 2) Japanese Laid-Open Publication No. 5-197622 (FIG. 1)

(Non-patent document 1) John L. Hennessy & David A. Patterson “Computer Architecture A Quantitative Approach Third Edition” Chapter Six Multiprocessors and Thread-Level Parallelism Snooping Protocols [P.551]

However, when a multiprocessor is used, conventionally used software cannot be used as it is. For example, in the case of built-in software adopting a Linux OS, it is possible to use a multiprocessor after minimizing modification to the software by using an OS such as a multiprocessor-adaptable Linux and by making the OS conform to the POSIX multithreading library. Nevertheless, when built-in software including no OS, and μITRON or other OSes that are lagging behind in terms of adaptation to multiprocessor are adopted, it is necessary to consider man-hours for the software development.

Also, even in a case where adaptation to multiprocessor may be necessary in the future, a development method may be taken in which software for single processor architecture is first developed and then the software is continuously adapted to multiprocessor in the platform thereof in consideration of man-hours for the software development. Furthermore, depending upon a failure point in hardware, all caches are available but a processor or processors are not available in some cases. In such cases, the multiprocessor may be also used as a single processor.

As described above, even for a chip whose performance has been improved by multiprocessor technology, it is necessary to consider a case in which an arithmetic processing unit including a multiprocessor is used as a single processor.

However, in a multiprocessor-architecture arithmetic processing unit, when only a single processor is used, a problem occurs in that the available cache capacity is only equal to the capacity of local caches, causing decrease in the cache capacity and hence in cache hit ratio.

### SUMMARY OF THE INVENTION

It is an object of the present invention to effectively use, in a multiprocessor-architecture arithmetic processing unit, the cache capacity of the multiprocessor and avoid decrease in cache hit ratio, when the multiprocessor is used as a single processor.

According to the present invention, when a multiprocessor is used as a single processor, a local cache coupled to a processor that is not to be used is used as a local cache of the processor to be operated by effectively utilizing snoop cache function resource.

Specifically, the present invention is directed to an arithmetic processing unit including a plurality of processors each having a CPU and a local cache, wherein the plurality of processors are coupled to common shared bus control means including a shared bus and a control section for controlling the shared bus; the local cache of each of the plurality of processors includes a cache memory and cache control means; and the cache control means includes: cache access control means coupled to local cache access address input means for receiving an access address from the CPU and to remote cache access address input means for receiving an access address from the shared bus and configured to access the cache memory by using the access address obtained from either the local cache access address input means or the remote cache access address input means, cache access transmission means coupled to the local cache access address input means and to remote cache access address output means for outputting an access address to the shared bus, and having function of outputting the access address obtained from the local cache access address input means to the shared bus by using the remote cache access address output means, and cache operation mode selection means configured to be capable of setting operation in single cache operation mode or operation in snoop cache operation mode.

According to the present invention, in the cache control means of the local cache, the cache access transmission means is capable of outputting the access address obtained from the CPU by way of the local cache access address input means to the shared bus through the remote cache access address output means. The cache access control means is capable of accessing the cache memory by using the access address obtained from the CPU by way of the local cache access address input means, while being capable of accessing the cache memory by using the access address obtained from the shared bus by way of the remote cache access address input means. That is, an access address output from the CPU in a processor is output to the shared bus from the cache access transmission means in that processor and received from the shared bus by the cache access control means in a different processor so as to be used in accessing the cache memory in that different processor. Therefore, when a processor is operated singly, the cache memories in the other processors can be used as the local caches of that singly operated processor.

And in the inventive arithmetic processing unit, when the cache operation mode selection means sets the single cache operation mode, in a first processor of the plurality of processors, which is to be operated, the local cache access address input means is validated, while the remote cache access address input means is invalidated, the cache access control means accesses the cache memory by using the access address obtained from the local cache access address input means, and the cache access transmission means outputs the access address obtained from the local cache access address input means to the shared bus by using the remote cache access address output means, and in each processor of the plurality of processors other than the first processor, the local cache access address input means is invalidated, while the remote cache access address input means is validated, the cache access control means accesses the cache memory by using the access address obtained from the remote cache access address input means, and the cache access transmission means does not output the access address to the shared bus.

Also, a method for performing cache operation in the inventive arithmetic processing unit includes: a first step of setting the single cache operation mode or the snoop cache operation mode in the cache operation mode selection means; a second step of, when the single cache operation mode is set in the first step, in a first processor of the plurality of processors, which is to be operated, validating the local cache access address input means, while invalidating the remote cache access address input means, accessing the cache memory by the cache access control means by using the access address obtained from the local cache access address input means, and outputting, by the cache access transmission means, the access address obtained from the local cache access address input means to the shared bus by using the remote cache access address output means; and a third step of, when the single cache operation mode is set in the first step, in each processor of the plurality of processors other than the first processor, invalidating the local cache access address input means, while validating the remote cache access address input means, accessing the cache memory by the cache access control means by using the access address obtained from the remote cache access address input means, and outputting no access address by the cache access transmission means to the shared bus.

As described above, according to the present invention, when the multiprocessor-architecture arithmetic processing unit is used as a single processor, the cache memories of the other processors that are not to be operated can be used as the local caches of the processor to be operated. It is therefore possible to avoid decrease in cache hit ratio caused by cache capacity decrease.

### BRIEF DESCRIPTION OF THE DRAWINGS

FIG. 1 illustrates the configuration of a multiprocessor functioning as an arithmetic processing unit according to an embodiment of the present invention.

### DETAILED DESCRIPTION OF THE INVENTION

Hereinafter, embodiments of the present invention will be described with reference to the accompanying drawings.

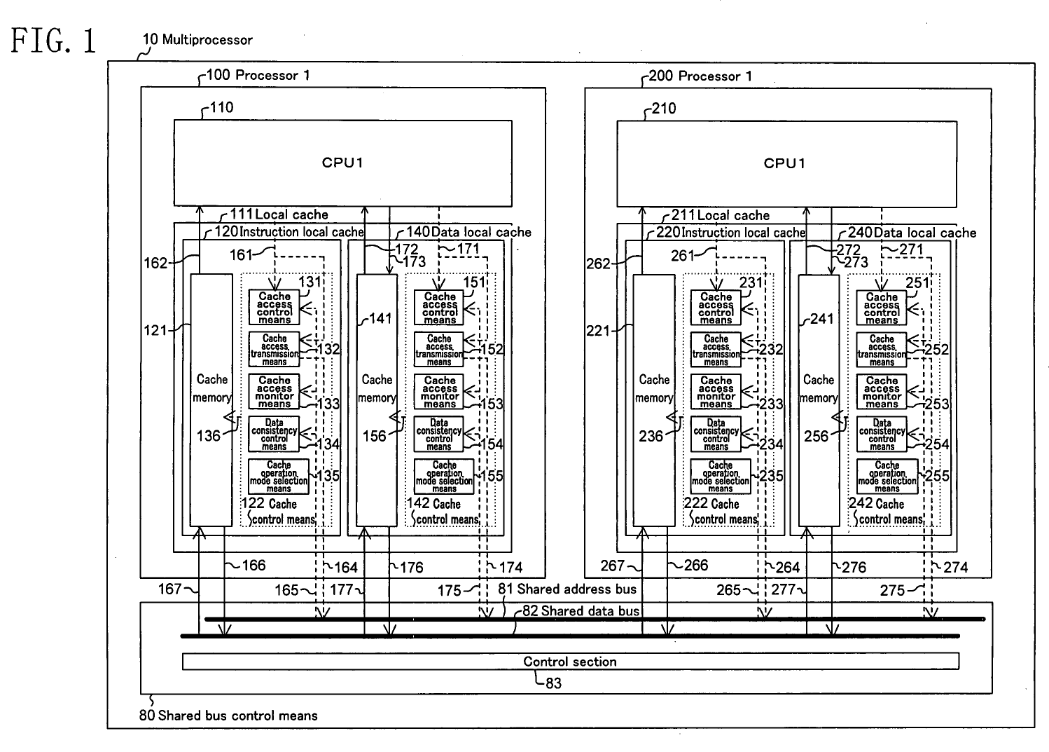

FIG. 1 illustrates the configuration of a function block in a multiprocessor 10 functioning as an arithmetic processing unit according to this embodiment. The multiprocessor 10 includes two processors 100 and 200 and a shared bus control means 80, which includes a shared address bus 81 and a shared data bus 82, serving as shared buses, and a control section 83 for controlling the shared buses. The processors 100 and 200 are both coupled to the shared bus control means 80.

The processor 100 (200) includes a CPU 110 (210) and a local cache 111 (211), and the local cache 111 (211) is composed of an instruction local cache 120 (220) and a data local cache 140 (240). The instruction local cache 120 (220) includes a cache memory 121 (221) and a cache control means 122 (222), while the data local cache 140 (240) includes a cache memory 141 (241) and a cache control means 142 (242). In this embodiment, the components of the processor 200 that are the same as those of the processor 100 are indicated by reference numerals in parentheses.

The cache control means 122 and 142 (222 and 242) include: cache access control means 131 and 151 (231 and 251) for transmitting from the CPU 110 (210) requests to access the cache memories 121 and 141 (221 and 241); cache access transmission means 132 and 152 (232 and 252) for transmitting the contents of access to the other local cache; cache access monitor means 133 and 153 (233 and 253) for monitoring contents accessed by the other local cache; data consistency control means 134 and 154 (234 and 254) for controlling data transmission between the CPU 110 (210) and an external memory and the data consistency thereof and controlling data transmission among the caches and the data consistency thereof; and cache operation mode selection means 135 and 155 (235 and 255) for storing cache operation mode that indicates whether each local cache 111 (211) in the multiprocessor 10 operates as a snoop cache or as a single cache.

The cache operation mode selection means 135, 155, 235, and 255 are composed of registers, for example, and configured so as to be capable of setting either a snoop cache operation mode or a single cache operation mode according to an external setting signal in common.

The instruction local cache 120 (220) is coupled to the CPU 110 (210) and to the shared bus control means 80. A local cache access address input means 161 (261) for transmitting a fetch address from the CPU 110 (210), and a local cache access data output means 162 (262) for transmitting an instruction corresponding to the fetch address from the CPU 110 (210) are provided between the instruction local cache 120 (220) and the CPU 110 (210).

There are provided, between the instruction local cache 120 (220) and the shared bus control means 80, a remote cache access address output means 164 (264) for transmitting a fetch address from the instruction local cache 120 (220), and a remote cache access data input means 167 (267) for transmitting an instruction, which corresponds to the fetch address from the instruction local cache 120 (220), and shared data from the other local caches 140, 220, and 240 (120, 140, and 240). The remote cache access address output means 164 (264) is coupled to the shared address bus 81 of the shared bus control means 80, while the remote cache access data input means 167 (267) is coupled to the shared data bus 82 of the shared bus control means 80. And a remote cache access address input means 165 (265) for transmitting the contents of access of the other local caches 140, 220, and 240 (120, 140, and 240) and a remote cache access data output means 166 (266) for transmitting data from the instruction local cache 120 (220) to the shared bus control means 80 are provided for data transmission to/from the other local caches 140, 220, and 240 (120, 140, and 240). The remote cache access address input means 165 (265) is coupled to the shared address bus 81 of the shared bus control means 80, while the remote cache access data output means 166 (266) is coupled to the shared data bus 82 of the shared bus control means 80.

The data local cache 140 (240) is coupled to the CPU 110 (210) and to the shared bus control means 80. There are provided, between the data local cache 140 (240) and the CPU 110 (210), a local cache access address input means 171 (271) for transmitting read and write addresses from the CPU 110 (210), a local cache access data output means 172 (272) for transmitting data corresponding to the read address from the CPU 110 (210), and a local cache access data input means 173 (273) for transmitting data corresponding to the write address from the CPU 110 (210).

Between the data local cache 140 (240) and the shared bus control means 80, there are provided a remote cache access address output means 174 (274) for transmitting data-read and data-write addresses from the data local cache 140 (240), and a remote cache access data input means 177 (277) for transmitting data, which corresponds to the read address from the data local cache 140 (240), and shared data from the other local caches 120, 220, and 240 (120, 140, and 220). The remote cache access address output means 174 (274) is coupled to the shared address bus 81 of the shared bus control means 80, while the remote cache access data input means 177 (277) is coupled to the shared data bus 82 of the shared bus control means 80. And a remote cache access address input means 175 (275) for transmitting the contents of access of the other local caches 120, 220, and 240 (120, 140, and 220), and a remote cache access data output means 176 (276) for transmitting data from the data local cache 140 (240) to an external memory and the like are also provided for data transmission to/from the other local caches 120, 220, and 240 (120, 140, and 220). The remote cache access address input means 175 (275) is coupled to the shared address bus 81 of the shared bus control means 80, while the remote cache access data output means 176 (276) is coupled to the shared data bus 82 of the shared bus control means 80.

The cache access control means 131 and 151 (231 and 251) are coupled to the local cache access address input means 161 and 171 (261 and 271) for receiving access addresses from the CPU 110 (210), as well as to the remote cache access address input means 165 and 175 (265 and 275) for receiving access addresses from the shared address bus 81. And the cache access control means 131 and 151 (231 and 251) access the cache memories 121 and 141 (221 and 241) by using the access addresses received from the local cache access address input means 161 and 171 (261 and 271) or from the remote cache access address input means 165 and 175 (265 and 275).

The cache access transmission means 132 and 152 (232 and 252) are coupled to the local cache access address input means 161 and 171 (261 and 271) and to the remote cache access address output means 164 and 174 (264 and 274) for outputting access addresses to the shared address bus 81. The cache access transmission means 132 and 152 (232 and 252) are configured so that, upon receipt of access addresses from the local cache access address input means 161 and 171 (261 and 271), they can output those access addresses to the shared address bus 81 by using the remote cache access address output means 164 and 174 (264 and 274).

The cache access monitor means 133 and 153 (233 and 253) are coupled to the remote cache access address input means 165 and 175 (265 and 275).

The data consistency control means 134 and 154 (234 and 254) are coupled to the remote cache access address input means 165 and 175 (265 and 275).

And the cache operation mode selection means 135 and 155 (235 and 255) are coupled to the cache access control means 131 and 151 (231 and 251), the cache access transmission means 132 and 152 (232 and 252), the cache access monitor means 133 and 153 (233 and 253), and the data consistency control means 134 and 154 (234 and 254). That is, the cache access control means 131 and 151 (231 and 251), the cache access transmission means 132 and 152 (232 and 252), the cache access monitor means 133 and 153 (233 and 253), and the data consistency control means 134 and 154 (234 and 254) operate in accordance with operation mode set in the cache operation mode selection means 135 and 155 (235 and 255).

In this embodiment, the shared address bus 81 and the shared data bus 82 disposed in the shared bus control means 80 are used both in the case of access to the external memory and in the case of access among the caches. However, in order to avoid bus contention as much as possible, a bus for the external memory and a bus for access among the caches may be separately provided, and therefore the present invention is not limited to the above-described configuration.

Also, in FIG. 1, the input and output means indicated by the solid and dashed arrows are realized by signal-transmitting buses and controllers thereof.

Hereinafter, it will be described how the arithmetic processing unit of FIG. 1 operates in each operation mode.

First, a case in which snoop cache operation mode is set in the cache operation mode selection means 135 and 155 (235 and 255) will be described.

In memory access from the CPU 110 (210) to the instruction local cache 120 (220) and to the data local cache 140 (240), the cache access control means 131 and 151 (231 and 251) receive access addresses to the cache memories 121 and 141 (221 and 241) by using the local cache access address input means 161 and 171 (261 and 271) so as to allow the local cache access by the CPU 110 (210) thereof and then access the cache memories 121 and 141 (221 and 241) by way of cache memory address output means 136 and 156 (236 and 256).

At this time, in the case of (non-cache) read access in which no caches will be used, (non-cache) write access in which no caches will be used, (cache) write access in which caches will be used, and cache miss access in (cache) read access in which caches will be used, the cache access transmission means 132 and 152 (232 and 252) transmit, as transmission signals, the access addresses obtained by the local cache access address input means 161 and 171 (261 and 271) to the shared bus control means 80 via the remote cache access address output means 164 and 174 (264 and 274). With these transmission signals, the other local caches can determine whether or not processing for maintaining data consistency is necessary.

The cache access monitor means 133 and 153 (233 and 253) search the cache memories 121 and 141 (221 and 241) of the local cache 120 (220) thereof, when the transmission signals are transmitted from the cache access transmission means 232 and 252 (132 and 152) of the other local cache 220 (120).

And when the transmission signals were transmitted due to non-cache read access or cache miss access in cache read operation, the data consistency control means 134 and 154 (234 and 254) operate as follows. When the local cache 120 (220) thereof stores access target data in the other local cache 220 (120), the data consistency control means 134 and 154 (234 and 254) exercise control so that the local cache 120 (220) thereof outputs the target data or the target entry data to the shared bus control means 80.

If the transmission signals were transmitted due to cache hit access in cache write operation, the data consistency control means 134 and 154 (234 and 254) operate as follows. When the local cache 120 (220) thereof stores access target data in the other local cache 220 (120), the data consistency control means 134 and 154 (234 and 254) exercise control so that the local cache 120 (220) thereof updates, as memory information, the target data output from the other local cache 220 (120) to the shared bus control means 80 or invalidates the target entry memory information.

If the transmission signals were transmitted due to cache miss access in cache write operation, the data consistency control means 134 and 154 (234 and 254) operate as follows. When the local cache 120 (220) thereof stores access target data in the other local cache 220 (120), the data consistency control means 134 and 154 (234 and 254) exercise control so that the local cache 120 (220) thereof updates, as memory information, the target data output from the other local cache 220 (120) to the shared bus control means 80 and outputs the target entry data to the shared bus control means 80. And the data consistency control means 234 and 254 (134 and 154) of the other local cache 220 (120) update, as memory information, the target data output to the shared bus control means 80 or invalidate the target entry memory information.

If the transmission signals were transmitted due to non-cache write access, the data consistency control means 134 and 154 (234 and 254) operate as follows. When the local cache 120 (220) thereof stores access target data in the other local cache 220 (120), the data consistency control means 134 and 154 (234 and 254) exercise control so that the local cache 120 (220) thereof updates, as memory information, the target data output from the other local cache 220 (120) to the shared bus control means 80 or invalidates the target entry memory information.

The data consistency control means 134 and 154 (234 and 254) also control data transmission to/from the external memory and the data consistency thereof. In this embodiment, it has been described that even in the case of non-cache access, control by the data consistency control means is performed so that the target data is updated as memory information or the target entry memory information is invalidated. However, non-cache access can be considered as access in which no data consistency control is performed, and the present invention is thus not limited to the above description.

Next, a case in which single cache operation mode is set in the cache operation mode selection means 135 and 155 (235 and 255) will be discussed. In this case, it is assumed that the processor 100, as the first processor, operates as a single processor. Selection of the processor to be operated may be made by register setting, for example, and it is possible to switch the processor to be operated to another processor.

In the local cache 111 in the processor 100, the local cache access address input means 161 and 171 are validated, while the remote cache access address input means 165 and 175 are invalidated. On the other hand, in the local cache 211 in the processor 200, the local cache access address input means 261 and 271 are invalidated, while the remote cache access address input means 265 and 275 are validated.

In the processor 100, the cache access control means 131 and 151 obtain access addresses to the cache memories 121 and 141 by the local cache access address input means 161 and 171 so as to allow local cache access by the CPU 110, and output the obtained access addresses to the cache memories 121 and 141 via the cache memory address output means 136 and 156. The cache access transmission means 132 and 152 always transmit, as transmission signals, the access addressees obtained by the local cache access address input means 161 and 171 to the shared address bus 81 of the shared bus control means 80 by way of the remote cache access address output means 164 and 174. These transmission signals allow the local cache 220 in the processor other than the processor 100, that is, in the processor 200, to operate as the local cache for the CPU 110.

On the other hand, in the processor 200, the cache access control means 231 and 251 obtain access addresses to the cache memories 221 and 241 by the remote cache access address input means 265 and 267 so as to allow local cache access by the CPU 110, and output the obtained access addresses to the cache memories 221 and 241 through the cache memory address output means 236 and 256. The cache access transmission means 232 and 252 do not transmit, at any time, the obtained access addressees to the shared address bus 81 of the shared bus control means 80 via the remote cache access address output means 264 and 274.

In the single cache operation mode, the cache access monitor means 133 and 153 (233 and 253) do not operate. And the data consistency control means 134 and 154 (234 and 254) do not operate in relation with control of data transmission among the caches and the data consistency thereof, and operate only in relation with control of data transmission to/from the external memory and the data consistency thereof.

As described above, when the cache operation mode selection means 135, 155, 235, and 255 select the snoop cache operation mode, the local cache 111 in the processor 100 and the local cache 211 in the processor 200 operate as the local caches of the respective CPUs 110 and 210, while being capable of performing the snoop operation as the remote cache of the other CPU 210 and 110.

Also, when the cache operation mode selection means 135, 155, 235, and 255 select the single cache operation mode, the local cache 111 in the processor 100 and the local cache 211 in the processor 200 are both accessed by way of the cache memory address output means 136, 156, 236, and 256 in accordance with access addresses obtained from the CPU 110 through the local cache access address input means 161 and 171. That is, the local caches 111 and 211 are both allowed to operate as the local caches of the CPU 110. It is therefore possible to avoid decrease in cache hit ratio caused by cache capacity decrease.

In the exemplary case described in this embodiment, a multiprocessor including two processors is used, but the present invention is not limited to this. A multiprocessor including three or more processors can also be realized in the same manner as in this embodiment. In that case, in the single cache operation mode, all cache memories can be used as single caches of the CPU to be operated, such that the same effects as those of this embodiment can be achieved.

Although, for ease of explanation, transmission between the data local caches has only been mentioned as transmission between the caches in part of the descriptions in this embodiment, the present invention is not limited to this, but transmission between the instruction local caches can also be realized in the same manner.

According to the present invention, when a multiprocessor-architecture arithmetic processing unit is used as a single processor, decrease in cache hit ratio is avoided. The present invention is thus effective in enhancing the performance of an arithmetic processing unit, when the arithmetic processing unit is used as a single processor, for example.

What is claimed is:

1. An arithmetic processing unit including a plurality of processors each having a CPU and a local cache, wherein
the plurality of processors are coupled to common shared bus control means including a shared bus and a control section for controlling the shared bus;
the local cache of each of the plurality of processors includes a cache memory and cache control means; and
the cache control means includes:
cache access control means coupled to local cache access address input means for receiving an access address from the CPU and to remote cache access address input means for receiving an access address from the shared bus and configured to access the cache memory by using the access address obtained from either the local cache access address input means or the remote cache access address input means,
cache access transmission means coupled to the local cache access address input means and to remote cache access address output means for outputting an access address to the shared bus, and having function of outputting the access address obtained from the local cache access address input means to the shared bus by using the remote cache access address output means, and
cache operation mode selection means configured to be capable of setting operation in single cache operation mode or operation in snoop cache operation mode.

2. The arithmetic processing unit of claim 1, wherein when the cache operation mode selection means sets the single cache operation mode,
in a first processor of the plurality of processors, which is to be operated,
the local cache access address input means is validated, while the remote cache access address input means is invalidated,
the cache access control means accesses the cache memory by using the access address obtained from the local cache access address input means, and
the cache access transmission means outputs the access address obtained from the local cache access address input means to the shared bus by using the remote cache access address output means, and
in each processor of the plurality of processors other than the first processor,
the local cache access address input means is invalidated, while the remote cache access address input means is validated,
the cache access control means accesses the cache memory by using the access address obtained from the remote cache access address input means, and
the cache access transmission means does not output the access address to the shared bus.

3. A method for performing cache operation in the arithmetic processing unit of claim 1, the method comprising:
a first step of setting the single cache operation mode or the snoop cache operation mode in the cache operation mode selection means;
a second step of, when the single cache operation mode is set in the first step, in a first processor of the plurality of processors, which is to be operated,
validating the local cache access address input means, while invalidating the remote cache access address input means,
accessing the cache memory by the cache access control means by using the access address obtained from the local cache access address input means, and
outputting, by the cache access transmission means, the access address obtained from the local cache access address input means to the shared bus by using the remote cache access address output means; and
a third step of, when the single cache operation mode is set in the first step, in each processor of the plurality of processors other than the first processor,
invalidating the local cache access address input means, while validating the remote cache access address input means,
accessing the cache memory by the cache access control means by using the access address obtained from the remote cache access address input means, and
outputting no access address by the cache access transmission means to the shared bus.
